(19) United States
(12) Patent Application Publication
(10) Pub. No.: US 2020/0080389 A1
(43) Pub. Date: Mar. 12, 2020

(54) METHOD AND APPARATUS FOR CONNECTING WELL EQUIPMENT

(71) Applicant: NCS MULTISTAGE INC., Calgary (CA)

(72) Inventors: Nick GETZLAF, Calgary (CA); Doug BRUNSKILL, Calgary (CA); Michael WERRIES, Calgary (CA)

(21) Appl. No.: 16/466,173

(22) PCT Filed: Dec. 1, 2017
(86) PCT No.: PCT/CA2017/051454

§ 371 Date: Jun. 3, 2019

Related U.S. Application Data
(60) Provisional application No. 62/429,538, filed on Dec. 2, 2016.

(51) Int. Cl. E21B 17/043; E21B 34/06; F16L 15/00

(52) U.S. Cl. CPC E21B 17/043; E21B 2034/007; F16L 15/001; E21B 34/06

(57) ABSTRACT

A wellbore equipment assembly and components for a wellbore equipment assembly are disclosed along with a method of connecting wellbore string components. In some embodiments, the assembly includes a first component and a second component with an end portion received in an end of the first component defining a connection or a joint. The first and second components include corresponding threads that together define a threaded region of the joint or connection. The first and second components also include corresponding interface surfaces that together define an interface region of the joint or connection that is spaced apart from the threaded region. The interface surfaces are sized such that the interface surface of the second component is urged into frictional engagement with the interface surface of the first component to bear at least part of a torque applied to the assembly.

### FIELD

This relates to well equipment and more particularly, to devices for connecting components in wellbores.

### BACKGROUND

Equipment is often installed within the bore of a well for performing functions such as pumping, transportation of fluids uphole or downhole, hydraulic fracturing and the like. Equipment may be located as much as hundreds of meters from the surface along the wellbore. Equipment may therefore be installed as part of a string so that it can be manipulated, for example, rotated from the surface. The string may be assembled by fastening (e.g. threading) components to one another.

During operation, components may be subjected to high torque or tensile loads. Accordingly, components may be tightly secured to one another. For example, threaded components may be tightened to very high torque values and joints between components may have to withstand very high torques during assembly of the string.

Unfortunately, existing designs tend to be difficult and costly to manufacture and prone to failure due to high applied torque. While interference fit threaded profiles for joints between components are known and may be used in high torque applications, these threaded profiles are not only complicated to design, calculate and manufacture but they are also not necessarily suitable for withstanding high tensile loads.

Accordingly, joining components together in a predictable manner that is less complicated to manufacture and that is able to withstand both high torque and tensile loads is desirable.

### SUMMARY

In one aspect, there is provided a wellbore equipment assembly, comprising: a first wellbore string component having a first thread; a second wellbore string component with an end portion received in an end of the first wellbore string component, the end portion having a second thread mated to the first thread, the first and second mated threads together defining a threaded region; the second wellbore string component having an interface surface sized such that the end portion is compressed by a corresponding interface surface on the first wellbore string component, such that the interface surface of the end portion of the second wellbore string component is urged into frictional engagement with the interface surface of the first wellbore string component to bear at least part of a torque applied to the wellbore equipment assembly; wherein:
the interface surface on the first wellbore string component and the interface surface on the second wellbore string component together define an interface region; and
the interface region is spaced apart from the threaded region.

In another aspect, there is provided a component for a wellbore string, comprising: a tubular body; an end portion defining a first thread and a first interface surface spaced apart from the first thread; wherein the end portion is sized for reception in an end of another wellbore string component such that the first thread mates with a corresponding second thread of the other wellbore string component to define a threaded region, and the first interface surface is compressed by a corresponding second interface surface on the other wellbore component, thereby urging the first interface surface into frictional engagement with the second interface surface to define an interface region.

In another aspect, there is provided a method of connecting wellbore string components, comprising: inserting a first wellbore string component in an end of a second wellbore string component; advancing the first wellbore string component into the second wellbore string component using threads, thereby forcing a first lock section of the first wellbore string component into engagement with a second lock section of the second wellbore string component, wherein the first and second lock sections are sized so that the second lock section compresses the first lock section, the first lock section and the second lock section together defining an interface region spaced apart from the threads; and holding the first and second wellbore string components together by frictional engagement between the first and second lock sections in the interface region.

In another aspect, there is provided a fracture sleeve housing for a hydraulic fracturing system, comprising: a body having a fluid passage therethrough; and an end portion for receiving a wellbore tube in communication with the fluid passage, the end portion having first threads for mating to corresponding second threads of the wellbore tube to define a threaded region, the end portion further defining a first interface surface sized to compress and frictionally engage a corresponding second interface surface of the wellbore tube to define an interface region.

### BRIEF DESCRIPTION OF DRAWINGS

In the drawings, which depict example embodiments:

FIG. 1 is a schematic view of a wellbore material transfer system at a geological formation;

FIG. 2 is a schematic view of a flow control apparatus of the wellbore material transfer system of FIG. 1;

FIG. 3 is an enlarged view of Detail “A” in FIG. 2;

FIG. 3A is an enlarged view of Detail “B” in FIG. 3;

FIG. 3B is an enlarged view of Detail “C” in FIG. 3;

FIG. 4 is an enlarged view of another flow control apparatus;

FIG. 4A is an enlarged view of Detail “D” in FIG. 4;

FIG. 5 is a flow chart of a method of making up a joint between wellbore string components.

### DETAILED DESCRIPTION

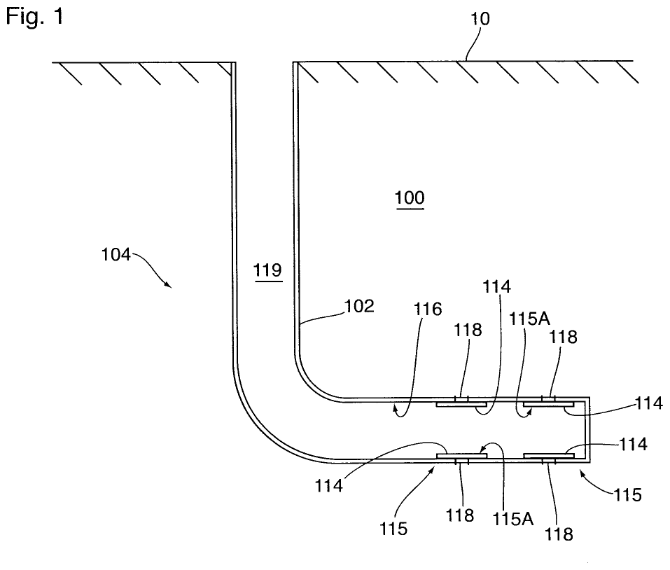

FIG. 1 depicts an example wellbore material transfer system 104 for conducting material to a subterranean formation 100 via a wellbore 102, from a subterranean formation 100 via a wellbore 102, or both to and from a subterranean formation 100 via a wellbore 102. In some embodiments, for example, the subterranean formation 100 is a hydrocarbon material-containing reservoir.

In some embodiments, for example, the conducting (such as, for example, by flowing) material to a subterranean formation 100 via a wellbore 102 is for effecting selective stimulation of a hydrocarbon material-containing reservoir. The stimulation is effected by supplying treatment material to the hydrocarbon material-containing reservoir. In some embodiments, for example, the treatment material is a liquid including water. In some embodiments, for example, the liquid includes water and chemical additives, e.g. solvents for promoting flowing of hydrocarbons within formation 100. In other embodiments, for example, the treatment material is a slurry including water, proppant, and chemical additives. Example chemical additives include acids, sodium chloride, polyacrylamide, ethylene glycol, borate salts, sodium and potassium carbonates, glutaraldehyde, guar gum and other water soluble gels, citric acid, and isopropanol. In some embodiments, for example, the treatment material is supplied to effect hydraulic fracturing of the reservoir. In some embodiments, for example, the treatment material includes water, and is supplied to effect waterflooding of the reservoir.

In some embodiments, for example, the conducting (such as, for example, by flowing) of material from a subterranean formation 100 via a wellbore 102 is for effecting production of hydrocarbon material from the hydrocarbon material-containing reservoir. In some of these embodiments, for example, the hydrocarbon material-containing reservoir, whose hydrocarbon material is being produced by the conducting via the wellbore 102, has been, prior to the producing, stimulated by the supplying of treatment material to the hydrocarbon material-containing reservoir.

In some embodiments, for example, the conducting to the subterranean formation 100 from the wellbore 102, or from the subterranean formation 100 to the wellbore 102, is effected via one or more flow communication stations 115 that are disposed at the interface between the subterranean formation 100 and the wellbore 102. In some embodiments, for example, the flow communication stations 115 are integrated within a wellbore string 116 that is deployed within the wellbore 102. Integration may be effected, for example, by way of threading or welding.

The wellbore string 116 includes one or more of pipe, casing, and liner, and may also include various forms of tubular segments. The wellbore string 116 defines a wellbore string passage 119. In some embodiments, for example, the flow communication station 115 is integratable within the wellbore string 116 by a threaded connection.

Successive flow communication stations 115 may be spaced from each other along the wellbore string 116 such that each flow communication station 115 is positioned adjacent a zone or interval of the subterranean formation 100 for effecting flow communication between the wellbore 102 and the zone (or interval).

For effecting the flow communication, the flow communication station 115 includes a flow control apparatus 115A. The flow control apparatus 115A includes one or more ports 118 through which the conducting of the material is effected. The ports 118 are disposed within a tubing segment (which may be referred to as a sub) that has been integrated within the wellbore string 116, and are pre-existing, in that the ports 118 exist before the sub, along with the wellbore string 116, has been installed downhole within the wellbore string 116.

The flow control apparatus 115A includes a flow control member 114 for controlling the conducting of material by the flow control apparatus 115A via the one or more ports 118. As depicted, the flow control member 114 is an annular sleeve, however other configurations are possible. The flow control member 114 is displaceable, relative to the one or more ports 118, for effecting opening of the one or more ports 118. In some embodiments, for example, the flow control member 114 is also displaceable, relative to the one or more ports 118, for effecting closing of the one or more ports 118. In this respect, the flow control member 114 is displaceable such that the flow control member 114 is positionable between open and closed positions. The open position of the flow control member 114 corresponds to an open condition of the one or more ports 118. The closed position of the flow control member 114 corresponds to a closed condition of the one or more ports 118.

In some embodiments, for example, the flow control member 114 is displaceable mechanically, such as, for example, with a shifting tool. In some embodiments, for example, the flow control member 114 is displaceable hydraulically, such as, for example, by communicating pressurized fluid via the wellbore to urge the displacement of the flow control member 114. In some embodiments, for example, the flow control member 114 is integrated within a flow control apparatus which includes a trigger for effecting displacement of the flow control member 114 hydraulically in response to receiving of a signal transmitted from the surface 10.

In some embodiments, for example, in the closed position, the one or more ports 118 are covered by the flow control member 114, and the displacement of the flow control member 114 to the open position effects at least a partial uncovering of the one or more ports 118 such that the 118 becomes disposed in the open condition. In some embodiments, for example, in the closed position, the flow control member 114 is disposed, relative to the one or more ports 118, such that a sealed interface is disposed between the wellbore string 116 and the subterranean formation 100, and the disposition of the sealed interface is such that the conduction of material between the wellbore string 116 and the subterranean formation 100, via the flow communication station 115 is prevented, or substantially prevented, and displacement of the flow control member 114 to the open position effects flow communication, via the one or more ports 118, between the wellbore string 116 and the subterranean formation 100, such that the conducting of material between the wellbore string 116 and the subterranean formation 100, via the flow communication station, is enabled. In some embodiments, for example, the sealed interface is established by sealing engagement between the flow control member 114 and the wellbore string 116. In some embodiments, for example, the flow control member 114 includes a sleeve. The sleeve is slideably disposed within the wellbore string passage 119.

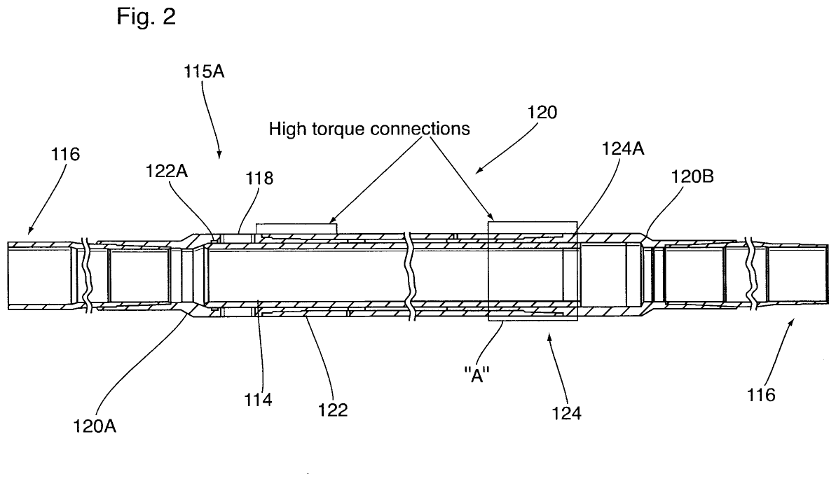

In some embodiments, for example, the flow control apparatus 115A includes a housing assembly 120. FIGS. 2 to 4 depict an example flow control apparatus 115A in greater detail. In some embodiments, for example, the housing assembly 120 includes an upper crossover sub 120A and a lower crossover sub 120B. Upper crossover sub 120A connects to housing 122 at the up-hole end of housing 122 and lower crossover sub 120B connects to housing 122 at the down-hole end of housing 122. Upper crossover sub 120A, housing 122 and lower crossover sub 120B cooperatively define a fluid flow path through flow control apparatus 115A. Fluid may be received at upper crossover sub 120A from up-hole components of wellbore string 116 and flow through lower crossover sub 120B toward downhole components of wellbore string 116. Alternatively or additionally, fluid may flow in an up-hole direction, from down-hole components of wellbore string 116, through lower crossover sub 120B and upper crossover sub 120A, and to up-hole components of wellbore string 116.

Upper crossover sub and lower crossover sub 120A, 120B may connect to housing 122 to define a fluid-tight seal and to mechanically couple crossover subs 120A, 120B, housing 122, and other components of wellbore string 116.

The housing assembly 120 includes one or more sealing surfaces configured for sealing engagement with a flow control member 114, wherein the sealing engagement defines the sealed interface described above. In this respect, sealing surfaces 122A, 124A are defined on an internal surface of the housing assembly 120 for sealing engagement with the flow control member 114. In some embodiments, for example, each one of the sealing surfaces 122A, 124A is defined by a respective sealing member. In some embodiments, for example, each one of the sealing members, independently, includes an o-ring, which may for example, be housed within a recess formed within the corresponding crossover sub 120A, 120B. In some embodiments, for example, the sealing member includes a molded sealing member (i.e. a sealing member that is fitted within, and/or bonded to, a groove formed within the sub that receives the sealing member). In some embodiments, for example, the port 118 extends through the housing assembly 120, and is disposed between the sealing surfaces 122A, 124A

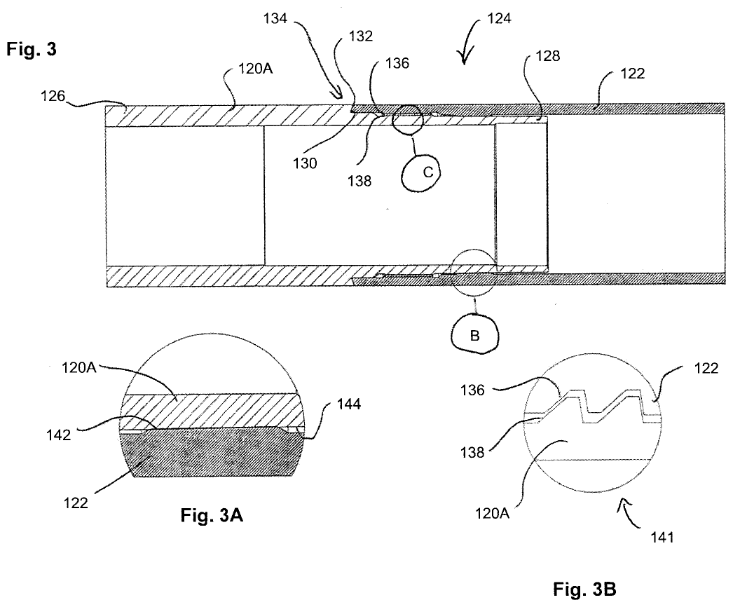

FIG. 3 depicts an enlarged partial cross-sectional view of housing 122 or first wellbore string component and upper crossover sub 120A or a second wellbore string component, showing a connection 124 between housing 122 and upper crossover sub 120A. The connected first and second wellbore string components form wellbore string assembly.

Upper crossover sub 120A has an outer barrel or annular tube section 126 and a shank or end portion 128. Shank or end portion 128 is defined by a section with diameter configured to be received in an end of the housing or first wellbore string component 122 and for engagement with housing 122 and, in some example embodiments is an annular shank. As shown, shank 128 has reduced outer diameter relative to barrel 126 for reception by housing 122. However, in other embodiments, shank 128 may have a relatively large diameter for receiving an end of housing 122.

Barrel 126 and shank or end portion 128 define a shoulder 130. With housing 122 and upper crossover sub 120A coupled, shoulder 130 abuts an end surface 132 of housing 122 to form a joint 134. Shoulder 130 is capable of applying a force or torque to housing 122 and end surface 132 is capable of applying a force or torque to upper crossover sub 120A. As used herein, references to transferring force also refer to transfer of torque or pressure. Shoulder 130 and end surface 132 may have complementary shapes, e.g. complementary flat annular, frustoconical or helical shapes.

As depicted, upper crossover sub 120A and housing 122 have a region with mating threads 141 as shown in a detail view of FIG. 3C. Crossover sub 120A and housing 122 may be assembled together by rotating one of crossover sub 120A and housing 122 relative to one another such that upper crossover sub 120A advances into housing 122 as the threads of crossover sub 120A bear against the threads of housing 122. In the depicted example, the end of housing 122 defines a thread on an internal surface, which may be referred to as a box, female or internal thread 136 and the end of crossover sub 120A defines a thread on an external surface, which may be referred to as a pin, male or external thread 138. Upper crossover sub 120A is received in housing 122 and pin thread 138 of upper crossover sub 120A engages box thread 136 of housing 122. Advancement of threads 136, 138 toward one another may be referred to as joint make up. The joint between housing 122 and upper crossover sub 120A is said to be fully made up when the threads 136, 138 are maximally advanced against one another.

In the fully made up state, shoulder 130 of upper crossover sub 120A and end surface 132 of housing 122 bear against one another and prevent further rotation of upper crossover sub 120A and housing 122 relative to one another.

As will be apparent, housing 122 and upper crossover sub 120A may apply loads to one another during installation and operation. For example, housing or first wellbore string component 122 and upper crossover sub or second wellbore string component 120A may apply torques and axial forces to one another. For example, torque may be applied during joint make-up and joint make-up may create tension and compression in the joint components. In addition, torque may be applied to wellbore string 116 above or below housing 122 and upper crossover sub 120A, causing torque to be transferred to the joint between housing 122 and upper crossover sub 120A. Torque may for example be applied during makeup of joints above housing 122 and upper crossover sub 120A and during cementing operations.

In some wellbore strings, forces (e.g. axial forces) and torque between housing 122 and upper crossover sub 120A is absorbed by shoulder 130 and end surface 132 bearing against one another, or by threads 136, 138, alone. For example, in some wellbore strings, threads 136, 138 may be sized for interference fit with one another so as to hold very large torques.

Unfortunately, application of force or torque causes stresses within housing or first wellbore string component 122 and upper crossover sub or second wellbore string component 120A. For example, torque may cause internal shear stress and axial loading may cause compressive or tensile stresses. Stress in housing 122 and upper crossover sub 120A can lead to failures. Failures may be particularly likely in regions of housing 122 or crossover sub 120A which have relatively low strength or in regions where part geometry causes stress concentrations. For example, housing 122 may buckle near end face 132 or upper crossover sub 120A may buckle near shoulder 130 or at shank 128. Moreover, while interference-fit threads may be used in order to withstand high torque loads, interference-fit threads require precision finishing operations (e.g. machining) and therefore tend to be difficult and expensive to produce.

Referring to FIGS. 3, 3A, and 3 B, in example embodiments of the present disclosure, upper crossover sub 120A and housing 122 have an interface region 140 defined by a friction section or locking section of housing 122 having an inner interface surface 142 and a corresponding friction section or torque bearing section or locking section of upper crossover sub 120A having an outer interface surface 144, the interface region 140 being spaced apart from and separate to the threaded region 141. In some embodiments, for example, the interface region 140 is spaced apart from the threaded region by a distance, measured along an axis that is parallel to the central longitudinal axis of the wellbore string assembly, of at least about 0.25 inches, such as, for example, at least 0.5 inches. Surfaces 142, 144 engage one another to align and lock or hold together upper crossover sub 120A and housing 122. Surfaces 142, 144 may have complementary frustoconical shapes in that the inner interface surface 142 of housing 122 tapers through the interface region 140 from a first inner diameter to a second, smaller inner diameter, while the outer interface surface 144 of upper crossover sub 120A tapers from a first outer diameter to a second, smaller outer diameter through the interface region 140 at the same angle as the inner interface surface 142 with the tapering outer diameter of the upper crossover sub 120A through the interface region 140 being larger than the tapering inner diameter of the housing 122 through the interface region 140. In some embodiments, for example, the angle of the taper of the inner and outer interface surfaces, relative to the central longitudinal axis of the wellbore string assembly, is between about 0.2 degrees and about 10 degrees, such as, for example between about 0.3 degrees and about 5 degrees, such as, for example, between about 0.6 degrees and about 0.7 degrees. As the joint between upper crossover sub 120A and housing 122 is made up, the interface surface or torque bearing section 144 of the end portion of the upper crossover sub 120A bears against the corresponding interface surface or locking section 142 of the housing 122 to align upper crossover sub 120A relative to housing 122 with the complementary tapered interface surfaces 142, 144 forming an interference fit through at least a portion of the interface region 140. In other embodiments, interface surfaces 142, 144 may be cylindrical or may have other complementary shapes that form an interference fit through the interface region 140 during joint make-up. In some embodiments, for example, the interface region 140 has an area of at least about eight (8) square inches, such as, for example, at least 12 square inches. In some example embodiments, the interface region 140 has a length, measured along an axis that is parallel to the central longitudinal axis of the wellbore string assembly, of at least about 0.5 inches, such as, for example at least 0.75 inches.

Housing 122 and upper crossover sub 120A may be sized to provide an interference fit between surfaces 142, 144. That is, in the depicted example embodiment, interface surface 144 of upper crossover sub 120A may define a frustoconical shape that is larger than a frustoconical shape defined by interface surface 142 of housing 122. For example, surface 144 may have a larger diameter, but may taper at the same angle, relative to surface 142. As the joint between upper crossover sub 120A and housing 122 is made up, the mating threads cause upper crossover sub 120A to advance into housing 122, forcing surface 144 to bear against surface 142. Since the outer interface surface 144 is larger than the inner interface surface 142, the interface surface 142 of housing 122 causes slight compression of the interface surface 144 of the upper crossover sub 120A through the interface region 140. Such compression may create significant pressure and friction between surfaces 142, 144 resulting in an interference fit which may withstand both high torque and tensile loads applied to the joint.

Surfaces 142, 144 may form a fit classified as an ANSI H8-x7 force fit, in the upper range. For example, surfaces 142, 144 may interfere with one another by between 0.0075″ to 0.0116″ on a nominal diameter of 4.945″. Surfaces 142, 144 may be treated for proper frictional engagement in the desired fit condition. For example, surfaces 142, 144 may be finished to a maximum average surface roughness of 16 micro inches. Surfaces 142, 144 and threads 136, 138 may be deburred using glass bead blasting and may be treated by liquid nitriding (surface hardening) or phosphate coating, as appropriate for the parent material. A friction-reducing molybdenum-disulphide dry spray may be applied to surfaces 142, 144 and to threads 136, 138. Thread compound may be applied to threads 136, 138.

Frictional engagement between surfaces 142, 144 may be sufficient to bear torsional loads experienced during installation and operation. In some embodiments, frictional engagement between surfaces 142, 144 is sufficient to withstand torsional loads of up to 5,000 ft-lbs.

In some embodiments, torque in excess of 10,000 ft-lbs may be applied to the joint between housing 122 and upper crossover sub 120A. Such applied torque may be first absorbed by the frictional engagement of the interference fit between surfaces 142, 144 within the interface region 140, and then by engagement between threads 136, 138 in the threaded region 141. Torque applied to threads 136, 138 may create corresponding tensile and compressive loads in housing 122 and crossover sub 120A, proportional to the amount of torque borne by the threads. Frictional engagement between surfaces 142, 144 may reduce torque borne by threads 136, 138 and thereby mitigate such tensile and compressive loads. That is, for a given applied torque, and relative to a joint lacking an interference fit between surfaces 142, 144 the torque borne by threads 136, 138 may be reduced according to the torque borne by friction and/or interference between surfaces 142, 144. Depending upon the particular application of the particular wellbore string components being joined and the specific torque and/or tensile loads that may be applied to the joint, the interface region 140 may be modified to suit the particular application. For example, in some embodiments, the length of the overall interface region 140 can be varied to ensure an appropriate interference fit is provided between the corresponding wellbore string components within the interface region 140. In other example embodiments, the interface region 140 may include a plurality of individual spaced apart interface regions 140 that each define an interference fit portion that makes up the overall interface region between the corresponding wellbore string components. Accordingly, it will be understood that there is a range of suitable interference defined by the interface region 140 such that sufficient interference between the corresponding wellbore string components is provided to withstand and/or accommodate the necessary torque and/or axial loads for a particular application while avoiding excessive interference that may produce high localized heat causing the components to weld together.

Surfaces 142, 144 may be cylindrical, rather than conical or frustoconical. In such cases, surface 144 may define a cylinder with larger diameter than that of surface 142. Advancement of upper crossover sub 120A into housing 122 forces surfaces 142, 144 into engagement, such that surface 142 urges surface 144 radially inwardly, compressing surface 144 and creating pressure and friction between the corresponding interface surfaces 142, 144 within the interface region 140.

In some embodiments, surfaces 142, 144 may have more complicated shapes. For example, surface 144 may have a tapered or conical section at its end, as well as a cylindrical section. In such embodiments, the tapered section may promote alignment and initial engagement of surfaces 142, 144.

Frictional engagement between surfaces 142, 144 may allow the joint between housing 122 and upper crossover sub 120A to withstand significant loads, e.g. torsional, compressive or tensile loads, without unduly pressurizing shoulder 130 and end surface 132 or threads 136, 138. Housing 122 and upper crossover sub 120A may have relatively large wall thickness in the region of surfaces 142, 144, and may therefore be capable of withstanding relatively large loads without failure. Moreover, frictional engagement between surfaces 142 may reduce or eliminate any need for threads 136, 138 to have an interference fit. This may limit the cost of producing threads 136, 138, as free-running threads may have larger tolerance ranges that interference-fit threads. The separation of the interface region 140 from the threaded region 141 of the joint or connection allows for an easier calculation, design and manufacture of the components which, in turn, may increase material selection options and may also reduce costs.

FIGS. 1 to 3 depict a joint between housing 122 and upper crossover sub 120A of a flow control apparatus 115A. Lower crossover sub 120B and housing 122 may be joined in substantially the same manner. For example, lower crossover sub 120B and housing 122 may define an interface region in which mating surfaces of the lower crossover sub 120B and housing 122 are sized to provide an interference fit when the joint is fully made up.

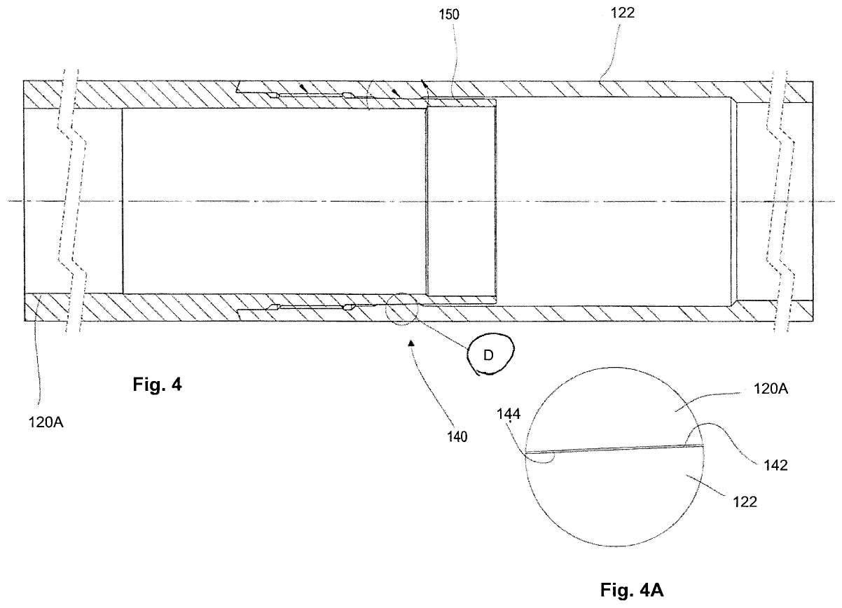

As depicted in FIGS. 1 to 3, shank or end portion 128 of upper crossover sub 120A is received through an end of housing 122. However, in some embodiments, housing 122 may instead have a shank or end portion with a smaller diameter than an end of upper crossover sub 120A, and the shank of housing 122 may be received by upper crossover sub 120A. One such embodiment is shown schematically in FIG. 4, with shank 150 of housing 122 received in upper crossover sub 120A. In the depicted embodiment, interface region 140 is defined by an outer surface 142 of shank 150 and an inner surface 144 of upper crossover sub 120A.

Connections as described herein may be used to couple components other than components of flow control apparatus 115A. For example, any sections of wellbore string 116 can be coupled using mating threaded ends and defining an interface region with an interference fit. Similarly, such joints may be used to connect sections of a wellbore casing, or to couple components such as pumps or the like to the wellbore string 116.

Additionally, such joints may be used to make-up joints in a fracture sleeve housing for a hydraulic fracturing system. In such example embodiments, the fracture sleeve housing may comprise a body having a fluid passage therethrough, the body having an end portion for receiving a wellbore tube in communication with the fluid passage. The end portion of the body of the fracture sleeve housing include a first portion defining threads for mating with corresponding threads on the wellbore tube and a second portion defining a friction surface sized to compress and frictionally engage a corresponding surface of the wellbore tube. In some embodiments, for example, the end portion is a socket for receiving an annular shank of the wellbore tube, and in some embodiments, for example, the friction surface is configured for an interference fit with the corresponding surface of the wellbore tube.

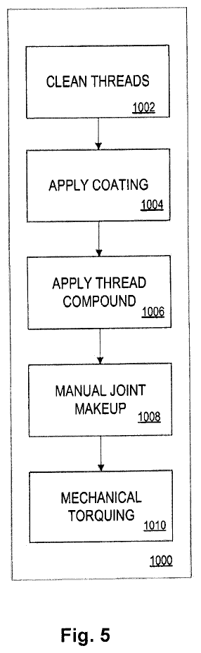

FIG. 5 depicts an example method 1000 of making up a joint. At block 1002, threads of the mating components are cleaned. For example, a surface treatment such as nitriding or phosphate treatment, may be applied to housing or a first wellbore string component 122 and upper crossover sub or a second wellbore string component 120A, which may leave debris. Thus, threads 136 of housing 122 and threads 138 of upper crossover sub 120A are cleaned to remove such debris, dust or the like.

At block 1004, a lubricant is applied to the mating surfaces of housing 122 and upper crossover sub 120A. In some embodiments, the lubricant may be a dry-film lubricant such as moly-mist™, made by Jet-Lube of Canada Ltd.

At block 1006, a thread compound, such as Bestolife 2000™ is applied to threads 136, 138.

At block 1008, a component is assembled to wellbore string 116 at the well surface. For example, upper crossover sub 120A is manually inserted into housing 122. Threads 136, 138 engage one another and the joint is manually tightened. In some embodiments, upper crossover sub 120A and housing 122 are manually tightened until shoulder 130 and end surface 132 are separated by a gap of approximately 0.5″-0.75″.

At block 1010, the joint is mechanically made up. Upper crossover sub 120A is mechanically gripped, e.g. using a clamp, tong, chuck or similar device, and is mechanically rotated to tighten crossover sub 120A against housing 122. To avoid damage, the gripping device may be positioned at least 8 inches away from the connection between crossover sub 120A and housing 122. Upper crossover sub 120A is turned to advance threads 136, 138. As threads 136, 138 advance, surfaces 142, 144 of interface region 140 progressively engage and interfere with one another, absorbing torque applied by the gripping device. In some embodiments, upper crossover sub 120A is turned at a maximum of 5 rpm to ensure correct threading and to avoid damage.

Specifications and test data for two example joints tested by the inventors is presented in Table 1 below.

TABLE 1
Example specifications of tested joints

| | |
|---|---|
| Connection Type 1 | Connection Type 2 |

GENERAL INFORMATION & DIMENSIONS

| | | | |
|---|---|---|---|
| Material | 41XX | L80-13Cr | — |
| Minimum Material Yield Strength | 110 | 80 | ksi |
| Connection Outside Diameter | 5.750 | 5.730 | inches |
| Connection Inside Diameter | 4.480 | 4.430 | lbs |
| Thread Type | 5.188″ - 8 TPI ANSI | 5.188″ - 8 TPI ANSI | |
| | BUTTRESS, GRADE 3 | BUTTRESS, GRADE 3 | |
| Taper Interference Length | 1.0 | 1.0 | inches |
| Taper Angle | 0.7 | 0.7 | ° |
| Taper Surface Roughness (Ra), as machined | 16 | 16 | micro inches |
| Interference Type | ANSI CLASS FN 5 - H8/x7 | ANSI CLASS FN 5 - H8/x7 | — |
| Diametrical Interference | 0.007-0.011 | 0.007-0.011 | inches |

FINISH & COATINGS

| | | | |
|---|---|---|---|
| Surface Treatment, First (THREAD & TAPER) | Glass bead blast (deburring) | Glass bead blast (deburring) | — |
| Surface Treatment, Second (THREAD & TAPER) | Zinc Phosphate | Liquid Nitride | — |
| Lubricant (THREAD & TAPER) | Dry Molybdenum Disulphide | Dry Molybdenum Disulphide | — |
| Thread compound (THREAD ONLY) | BESTOLIFE 2000 | BESTOLIFE 2000 | — |

CONNECTION PERFORMANCE PROPERTIES

| | | | |
|---|---|---|---|
| Tested Connection Compressive Strength | — | 270000 | lbs |
| Typical Shoulder Torque* | 1900 | 2800 | ft-lbs |
| Tested Connection Yield Torque | 16800 | 12000 | ft-lbs |
| Calculated Connection Tensile Yield Strength | 407000 | 324000 | lbs |

*approx. torque value it takes to shoulder connection

As will be apparent, method 1000 may be used to make up joints between any components of wellbore string 116. For example, method 1000 may be used to join components below lower crossover sub 120B; to join lower crossover sub 120B to wellbore string 116; to join housing 122 to lower crossover sub 120B; to join upper crossover sub 120A to housing 122; or to join wellbore string 116 to upper crossover sub 120A. In some embodiments, for example, the method 1000 may be used to join components of a fracture sleeve housing for a hydraulic fracturing system. Modifications are possible to the examples detailed herein. Accordingly, the detailed examples are not limiting. Rather, the invention is defined by the claims.

1. A wellbore equipment assembly, comprising:
a first wellbore string component having a first thread;
a second wellbore string component with an end portion received in an end of the first wellbore string component, the end portion having a second thread mated to the first thread, the first and second mated threads together defining a threaded region;
the second wellbore string component having an interface surface sized such that the end portion is compressed by a corresponding interface surface on the first wellbore string component, such that the interface surface of the end portion of the second wellbore string component is urged into frictional engagement with the interface surface of the first wellbore string component to bear at least part of a torque applied to the wellbore equipment assembly;
wherein:
the interface surface on the first wellbore string component and the interface surface on the second wellbore string component together define an interface region; and
the interface region is spaced apart from the threaded region.

2. The wellbore equipment assembly as claimed in claim 1;
wherein:
the first and second wellbore strings define a wellbore string assembly; and
the interface region is spaced apart from the threaded region by a distance, measured along an axis parallel to the central longitudinal axis of the wellbore string assembly, of at least about 0.25 inches.

3. The wellbore equipment assembly as claimed in claim 1;
wherein the interface region has an area of at least about eight (8) square inches.

4. The wellbore equipment assembly as claimed in claim 1;
wherein:
the first and second wellbore strings define a wellbore string assembly; and
the interface region has a length, measured along an axis parallel to the central longitudinal axis of the wellbore string assembly, of at least about 0.5 inches.

5. (canceled)

6. (canceled)

7. The wellbore equipment assembly as claimed claim 1;
wherein the first and second wellbore string components define a flow control assembly.

8. (canceled)

9. The wellbore equipment assembly as claimed in claim 1;
wherein the interface surface of the second wellbore string component is a torque bearing section and the interface surface of the first wellbore string component is a locking section, the torque bearing section and the locking section forming an interference fit.

10. The wellbore equipment assembly as claimed in claim 1;
wherein the interface surface of the second wellbore string component is a cylindrical outer surface having an outer diameter and the interface surface of the first wellbore string component is a cylindrical inner surface having an inner diameter, wherein the inner diameter is larger than the outer diameter.

11. The wellbore equipment assembly as claimed in claim 1;
wherein the interface surface of the second wellbore string component is a frustoconical outer surface.

12. The wellbore equipment assembly as claimed in claim 1;
wherein the interface surface of the first wellbore string component and the interface surface of the second wellbore string component are complementary frustoconical surfaces.

13. The wellbore equipment assembly as claimed in claim 12;
wherein:
the first and second wellbore strings define a wellbore string assembly; and
the complementary frustoconical surfaces both taper, relative to the central longitudinal axis of the wellbore string assembly, at an angle of between about 0.2 degrees and about 10 degrees.

14. The wellbore equipment assembly as claimed in claim 1;
wherein the second wellbore string component has an external shoulder abutting an end surface of the first wellbore string component.

15. (canceled)

16. A component for a wellbore string, comprising:
a tubular body;
an end portion defining a first thread and a first interface surface spaced apart from the first thread;
wherein the end portion is sized for reception in an end of another wellbore string component such that the first thread mates with a corresponding second thread of the other wellbore string component to define a threaded region, and the first interface surface is compressed by a corresponding second interface surface on the other wellbore component, thereby urging the first interface surface into frictional engagement with the second interface surface to define an interface region.

17. (canceled)

18. (canceled)

19. (canceled)

20. (canceled)

21. The component as claimed in claim 16;
wherein the first interface surface is a locking section for forming an interference fit with the second interface surface of the other wellbore string component.

22. The component as claimed in claim 16;
wherein the interface surface is a cylindrical outer surface of the tubular body.

23. The component as claimed in claim 16;
wherein the interface surface is a frustoconical outer surface of the tubular body.

24. (canceled)

25. The component as claimed in claim 16;
wherein:
the first interface surface is spaced apart from the first thread by a distance, measured along an axis parallel to the central longitudinal axis of the tubular body, of at least about 0.25 inches.

26. (canceled)

27. (canceled) The component as claimed in any one of claims 16 to 26;
wherein:
the first interface surface has a length, measured along an axis parallel to the central longitudinal axis of the tubular body, of at least about 0.5 inches.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. A fracture sleeve housing for a hydraulic fracturing system, comprising:
a body having a fluid passage therethrough; and
an end portion for receiving a wellbore tube in communication with the fluid passage, the end portion having first threads for mating to corresponding second threads of the wellbore tube to define a threaded region, the end portion further defining a first interface surface sized to compress and frictionally engage a corresponding second interface surface of the wellbore tube to define an interface region.

42. (canceled)

43. The fracture sleeve housing as claimed in claim 41;
wherein the first interface surface is configured to form an interference fit with the corresponding second interface surface of the wellbore tube.

44. The fracture sleeve housing as claimed in claim 41;
wherein the first interface surface is cylindrical.

45. The fracture sleeve housing as claimed in claim 41;
wherein:
the first interface surface is spaced apart from the first thread by a distance, measured along an axis parallel to the central longitudinal axis of the body, of at least about 0.25 inches.

46. (canceled)

47. (canceled)
